(19) United States
(12) Patent Application Publication
(10) Pub. No.: US 2025/0376299 A1
(43) Pub. Date: Dec. 11, 2025

(54) Eco-Friendly Bag with Integrated Marketing and Digital Coupon Redemption Platform

(71) Applicant: Jaipal Singh Mann, Waterdown (CA)

(72) Inventor: Jaipal Singh Mann, Waterdown (CA)

(21) Appl. No.: 18/739,375

(22) Filed: Jun. 11, 2024

(51) Int. Cl. B65D 33/00; B65D 33/12; B65D 65/46; G06K 19/06; G06Q 30/0207; G06Q 30/0251

(52) U.S. Cl. CPC B65D 33/004; B65D 33/12; B65D 65/466; G06K 19/06037; G06Q 30/0207; G06Q 30/0259; B65D 2565/383; B65D 2565/385

(57) ABSTRACT

The present invention relates to an eco-friendly bag that serves as a dual-purpose marketing platform, designed to address environmental concerns associated with paper waste and to provide a novel advertising space for brands. The bag is constructed from sustainable materials and features a main compartment with strong handles for secure transportation of food items. The exterior surface of the bag is utilized for displaying marketing content, including brand advertisements, promotions, and discount coupons. These coupons are uniquely designed with perforated lines for easy removal and are accompanied by instructions promoting recycling efforts. A distinctive feature of the bag is a scannable QR code that links to a mobile application, enabling digital redemption of the offers and providing analytics to brands on consumer engagement. This invention introduces a new segment within the marketing ecosystem, offering an alternative to traditional advertising channels, and contributes to the environment by recycling bags.

### CROSS-REFERENCE TO RELATED APPLICATIONS

No related applications are previously filed.

### FIELD OF THE INVENTION

The present invention relates to the field of environmental sustainability and marketing within the food service industry. More specifically, it pertains to an eco-friendly bag that serves a dual purpose as a marketing platform for businesses and brands. The invention introduces a novel approach to utilizing the exterior surface of bags for displaying advertisements, promotions, and coupons, thereby transforming a single-use item into a multi-functional product that contributes to waste reduction and offers a new avenue for brand engagement.

### BACKGROUND OF THE INVENTION

The proliferation of consumer goods has brought unparalleled convenience to modern lifestyles. Yet, this ease of access is accompanied by an environmental toll. The packaging used for transporting goods, which includes a variety of bags, is a major contributor to the escalating issue of waste accumulation. Recent research indicates that packaging materials constitute a significant fraction of municipal solid waste. This is not limited to food-related items but extends to a broad range of products. The manufacturing process for these bags depletes precious resources and leads to the emission of greenhouse gases and other pollutants, exacerbating environmental degradation.

In addition to the environmental concerns, the current use of bags represents a missed opportunity in the marketing landscape. The exterior of these bags is typically underutilized, offering a vast, untapped real estate for advertising. With the rise of digital marketing, brands are constantly seeking innovative and effective ways to reach consumers. Integrating digital platforms with physical marketing strategies, known as “phygital” marketing, has emerged as a powerful approach to create a cohesive customer experience. This integration allows for a seamless transition between online engagement and tangible, in-person interactions.

Existing prior art have explored the concept of advertising on packaging materials. However, these solutions have not fully leveraged the potential of combining eco-friendly packaging with a digital redemption platform to enhance marketing opportunities and consumer engagement4. There is a clear need for a solution that addresses both the environmental impact of bags and the underutilization of their marketing potential.

This invention aims to significantly mitigate the weekly paper waste generated from mail, which often includes advertisements, coupons, awareness campaigns, government policies, and neighborhood information. The clutter associated with these paper-based communications can be substantially reduced by repurposing the existing real estate of the takeout bag. By integrating marketing content directly onto the takeout bag, this invention leverages a common item in daily use to deliver important messages and offers, thereby minimizing the need for additional paper materials and contributing to environmental sustainability. This approach not only declutters mailboxes but also promotes eco-friendly practices by utilizing a reusable platform for information dissemination.

The present invention seeks to fill this gap by introducing an eco-friendly bag that doubles as a marketing platform. This innovative approach not only reduces paper waste but also transforms the bag into a valuable tool for brand promotion. The invention includes integrated discount coupons and QR codes, allowing for direct interaction with consumers and fostering a new avenue for cross-marketing opportunities. By repurposing the bag as an advertising medium, the invention creates a new segment within the marketing ecosystem, offering an alternative to the saturated digital marketing channels.

These and many other problems have been long identified. Different solutions to the problems have been tried. However, there exists no comprehensive solution to all the above problems. Therefore, the object of the invention overcomes the limitations and drawbacks from the prior art. To achieve the above and other objects, the present invention anticipates a new and entirely different system and method that resolves the limitations and drawbacks.

### SUMMARY OF THE INVENTION

Embodiments of the invention solve the above-mentioned problems by providing an eco-friendly bag that serves as a marketing platform, designed to address the environmental concerns of paper waste and offer a novel approach to brand promotion. The invention is characterized by its dual functionality: it is both a container for transporting food items and a medium for advertising.

The bag of the invention is made from durable, eco-friendly materials that are strong enough to securely carry any products, yet designed to be easily recyclable or reusable. The exterior of the bag features designated spaces for displaying advertisements, promotions, and discount coupons for various brands and services. These coupons can be redeemed by cutting them out or scanning a QR code, which is linked to a unique app developed for this purpose.

The invention provides several advantages over the prior art, including direct exposure of brand offers to consumers, a reduction in paper waste through the reuse of the bags for marketing purposes, and the creation of cross-marketing opportunities for businesses of all sizes. It also introduces a new segment within the marketing ecosystem, offering an alternative to traditional and digital marketing channels.

In summary, the invention presents an eco-friendly bag that doubles as a marketing platform, thereby contributing to environmental conservation and providing a new avenue for brand engagement.

This summary is provided merely for the purpose of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following detailed description, figures, and claims.

### BRIEF DESCRIPTION OF THE DRAWINGS

The prior and other objects of this invention, the various features thereof, as well as the invention itself, may be more fully understood from the following description, when read together with the accompanying drawings in which:

FIG. 1 diagrammatically visualizes the front view of one example of the bag further visualizing the different embodiment of the present invention.

FIG. 2 provides a visual representation of the rear view of one example of the bag further visualizing the different embodiment of the present invention.

FIG. 3 provides an open visualization of one example of the bag further reflecting the internal view.

FIG. 4 diagrammatically visualizes the front view of another example of the bag further visualizing the different embodiment of the present invention.

FIG. 5 provides a visual representation of the rear view of another example of the bag further visualizing the different embodiment of the present invention.

FIG. 6 provides an open visualization of another example of the bag further reflecting the internal view.

### DETAILED DESCRIPTION OF THE INVENTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, embodiments of the invention can include a variety of combinations and/or integrations of the embodiments described herein.

This invention relates to an eco-friendly bag that serves as a marketing platform, offering a sustainable solution to paper waste and a novel advertising medium for brands. The detailed description herein provides a clear understanding of the invention, its construction, and its method of operation, which can be readily understood and implemented by those skilled in the art of packaging and marketing.

The bag is constructed from biodegradable, recycled, or other eco-friendly materials that meet environmental standards for sustainability. The bag's design includes a main compartment for holding food items, with strong handles attached to ensure secure transportation. The exterior surface of the bag is treated as a canvas for marketing content, with designated areas for printed advertisements, promotions, 03, 04, 09-12, 20, 21 and discount coupons 01.

The marketing content on the bag's exterior includes visually appealing designs that incorporate brand logos, promotional messages 03, 04, 09-12, 20, 21 and discount offers. Each bag features a unique QR code 13 that customers can scan using a specially designed mobile application. This QR code 13 links to a digital coupon that can be stored within the app for later redemption.

The mobile application is an integral part of the invention, facilitating the digital redemption of coupons and offers featured on the bags. The app is designed to be user-friendly, with features that allow customers to scan QR codes 13, save coupons, and locate participating stores. The app also provides analytics to brands, giving them insights into customer engagement and the effectiveness of their advertisements.

The invention provides a dual benefit of reducing paper waste and offering a new marketing channel. By repurposing the bag as an advertising space, the invention encourages the reuse of bags, thereby contributing to environmental conservation. Additionally, the invention opens up cross-marketing opportunities for businesses, allowing them to reach customers directly through a physical medium complemented by a digital experience.

For example, restaurants and other food service establishments can implement the use of these bags as part of their packaging solutions. Brands interested in advertising can collaborate with these establishments to feature their content on the bags. Customers who receive these bags can interact with the marketing content, redeem offers, and contribute to environmental sustainability by reusing or recycling the bags.

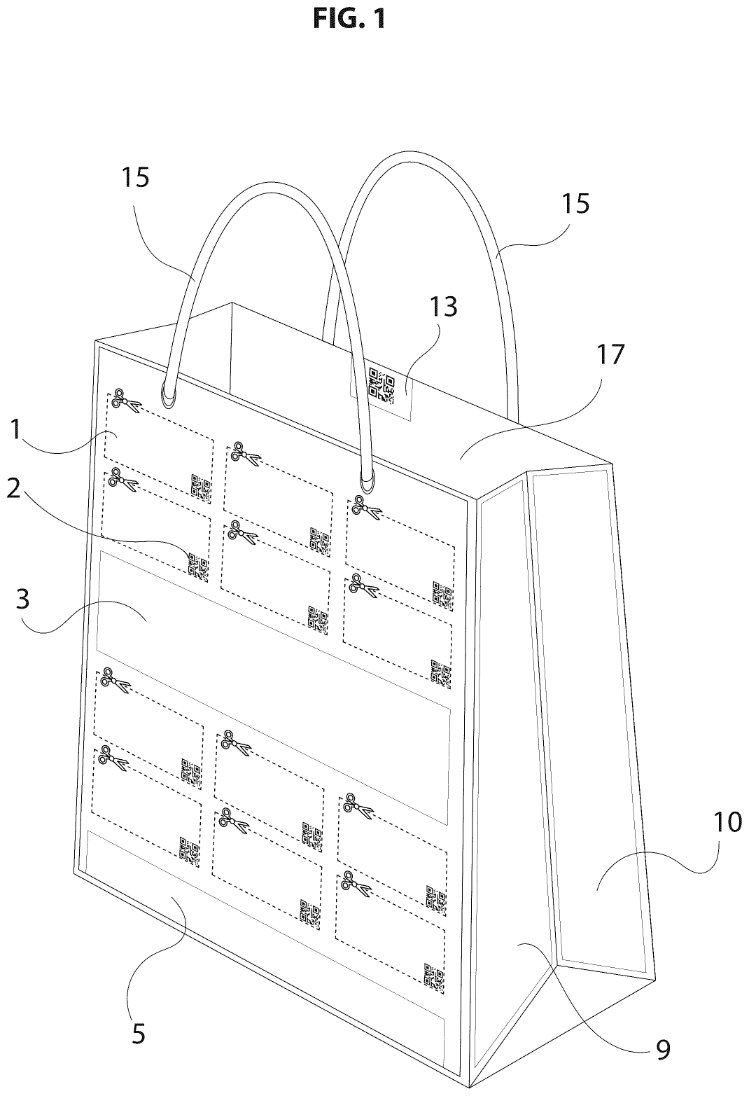

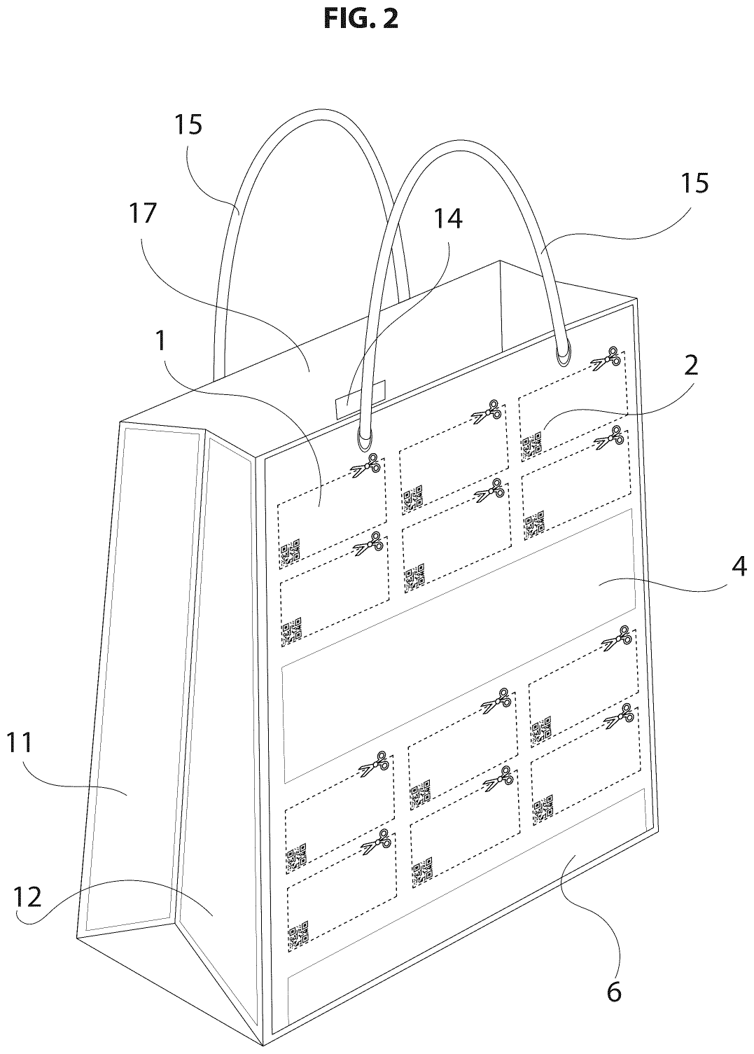

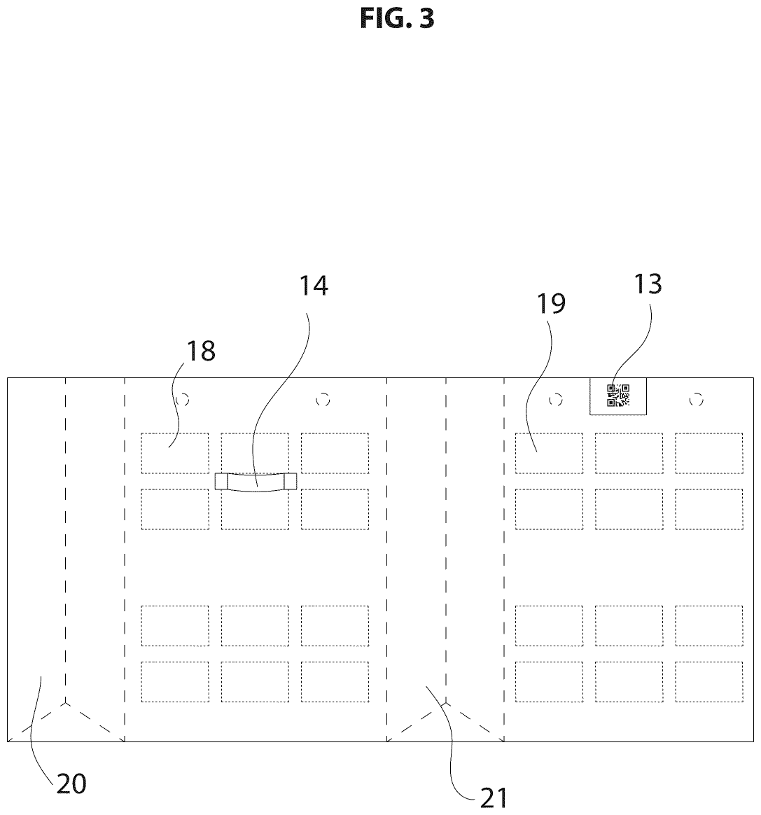

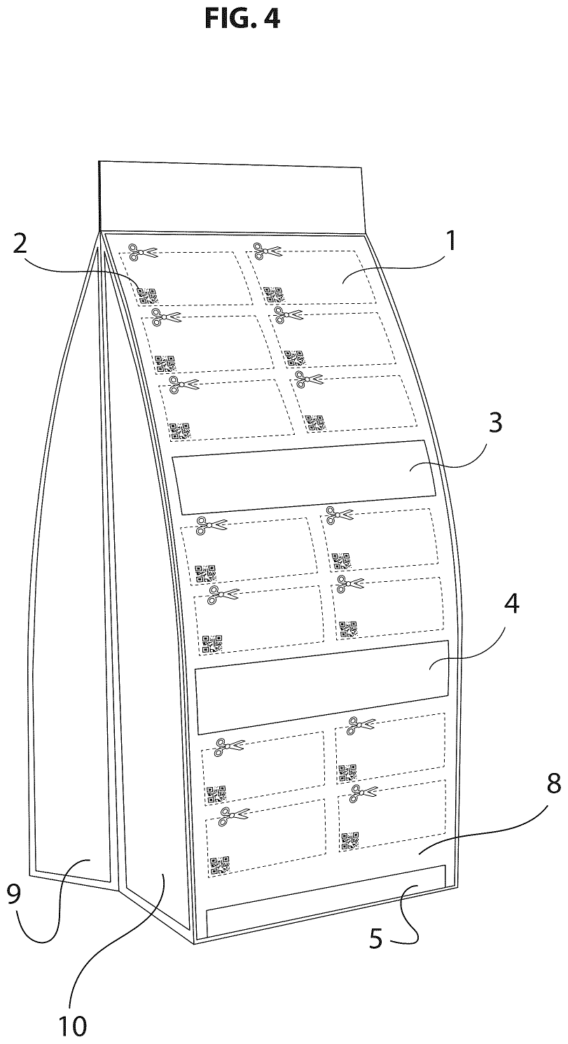

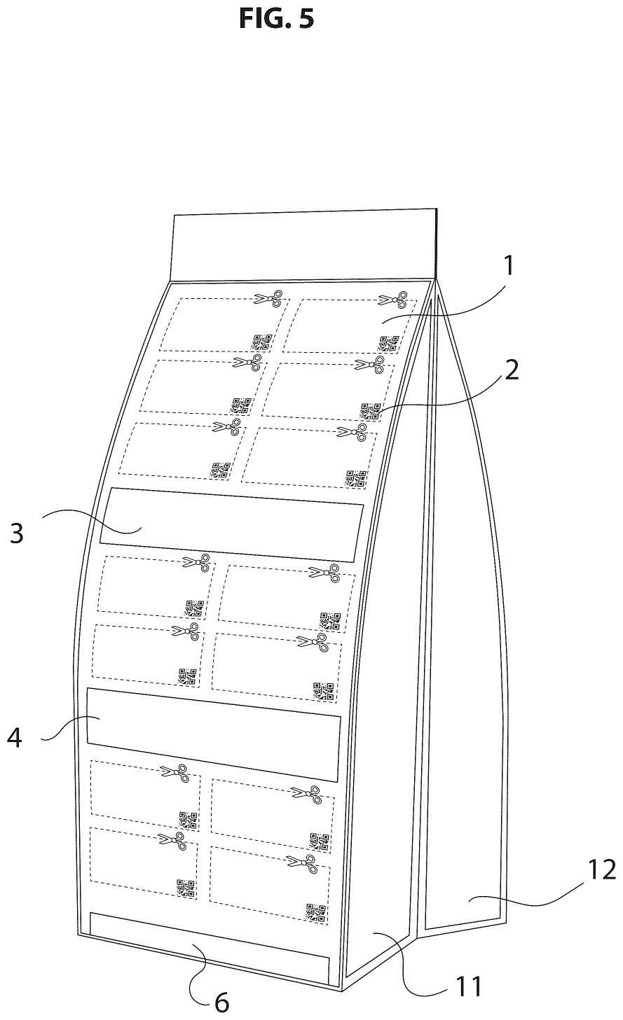

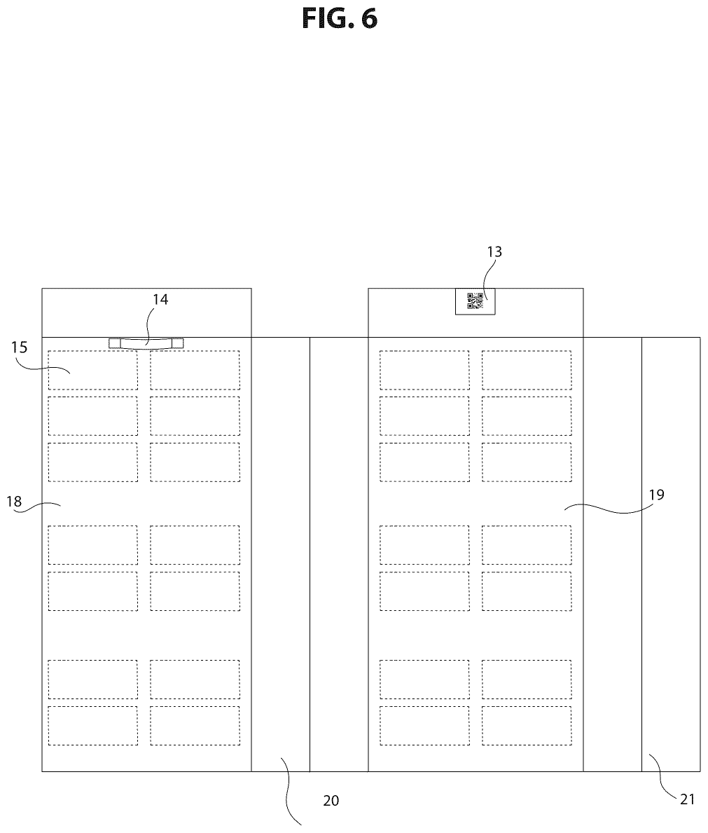

Turning to the figures and specifically FIG. 1 to FIG. 6, The preferred embodiment of the eco-friendly bag comprises a main compartment, strong handles 15, an exterior surface for marketing content, perforated lines for discount coupons 01, instructions for coupon redemption, and a unique QR code 13. The main compartment is sized to hold a variety of purchased items securely. The strong handles 15 are attached to the main compartment, ensuring safe and comfortable transportation. The exterior surface of the bag is designed to display marketing content, including advertisements 03, 04, 09-12, 20, 21 promotions, and discount coupons 01, which serve as an interactive interface between the consumer and the participating brands. The discount coupons 01 are surrounded by perforated lines, which facilitate the easy removal of the coupon 01 by cutting along these lines. Adjacent to each coupon 01, instructions are printed to guide the consumer on how to cut out and redeem the coupon, promoting a recycling initiative. The outer surface of the bag is additionally designed to feature contact information 05, 06 for the creators of the bag, offering a means for engagement for various reasons, such as but not limited to, inquiries and orders for the bags. Each bag features a unique QR code 13 that can be scanned using a mobile application to redeem associated offers, enhance customer engagement and provide a personalized experience. The bag also includes a unique product ID 14 which will work in synchronization with the QR code 13 for App scanning purposes to prevent theft and misuse by someone other than the customer.

In another embodiment, the material of the bag is selected from a group consisting of biodegradable materials, recycled materials, and other environmentally sustainable materials. This selection underscores the invention's commitment to environmental sustainability and reduces the ecological footprint associated with packaging.

Further embodiments of the invention relate to the marketing content displayed on the exterior surface of the bag. The content includes but is not limited to restaurant brands, concerts, movies, television series, online streaming services, or real estate applications. This embodiment creates a new segment within the marketing ecosystem, offering an alternative marketing channel to traditional and digital marketing methods. Augmented reality features included in the marketing content can be interacted with via the mobile application, providing an immersive experience for the consumer. The content is periodically updated to reflect current promotions and offers from participating brands, ensuring relevance and engagement. Customization based on geographic location allows for targeted marketing, enhancing the effectiveness of the campaigns. Additionally, the marketing content promotes cross-marketing opportunities for both large-scale businesses and small-scale businesses, fostering a collaborative marketing environment.

In another embodiment, the eco-friendly bag is designed to be reusable or recyclable. This design contributes to a reduction in paper waste and encourages consumers to participate in sustainable practices. The bag's durability and design for multiple uses align with environmental conservation efforts and provide a practical solution for consumers.

Another embodiment involves the use of a unique, dynamically generated QR code 13 for each bag. This feature provides personalized offers to consumers, enhancing the user experience and fostering brand loyalty. The dynamic nature of the QR code 13 generation ensures that each consumer receives unique and tailored promotions, adding value to the bag as a marketing tool.

A method embodiment outlines the utilization of the eco-friendly bag as a marketing platform. The method includes providing a bag made from environmentally sustainable materials, displaying marketing content 03, 04, 09-12, 20, 21 on the bag, distributing the bags through food service establishments, scanning the QR code 13 to access offers, analyzing consumer interaction data, updating marketing content periodically, customizing content based on various factors, and encouraging recycling of the bags.

The invention also encompasses a mobile application designed to work in conjunction with the eco-friendly bag. The application includes a user interface for scanning the QR code 13, a database for storing information associated with the scanned QR code 13, a redemption module, an analytics module, and a notification system. The redemption module allows users to redeem the discount coupon 01 or promotional offer easily. The analytics module collects data on user interactions, providing valuable insights to brands regarding customer preferences and the effectiveness of the marketing content. The notification system alerts users of new offers and promotions 03, 04, 09-12, 20, 21 and it can provide location-based alerts when a user is near participating stores, enhancing the shopping experience.

The eco-friendly bag and associated mobile application represent innovative contributions to sustainable packaging and marketing. The described embodiments offer a multifaceted approach to engaging consumers, promoting environmental responsibility, and providing a novel marketing platform for brands. The invention's adaptability and focus on sustainability make it a valuable addition to the consumer market.

This detailed description section provides clarity and guidance for those skilled in the art to understand and practice the invention, with the understanding that the description is exemplary and not limiting. The scope of the invention is defined by the appended claims.

The methods disclosed herein may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

The present invention is described above with reference to a preferred embodiment. However, those skilled in the art will recognize that changes and modifications may be made in the described embodiment without departing from the nature and scope of the present invention. To the extent that such modifications and variations do not depart from the spirit of the invention, they are intended to be included within the scope thereof.

Having fully and clearly described the invention so as to enable one having skill in the art to understand and practice the same, the invention claimed is:

1. An eco-friendly bag comprising:
a main compartment for holding purchased items;
strong handles attached to the main compartment for secure transportation;
an exterior surface designed to display marketing content, including advertisements, promotions, and discount coupons;
perforated lines surrounding each discount coupon printed on the exterior surface of the bag, wherein the perforated lines are designed to facilitate the physical removal of the coupon from the bag by cutting along the lines;
instructions printed adjacent to each coupon indicating the method of cutting out and redeeming the coupon as part of a recycling initiative; and
a unique QR code provided inside the bag, wherein the QR code is scannable by a mobile application to redeem associated offers.

2. The eco-friendly bag of claim 1, wherein the material of the bag is selected from the group consisting of: biodegradable materials, recycled materials, and other environmentally sustainable materials.

3. The eco-friendly bag of claim 1, wherein the marketing content includes, but is not limited to, promotional material associated with various forms of entertainment, services, and commercial offerings, thereby encompassing a wide range of potential advertising partners and sponsors.

4. The eco-friendly bag of claim 1, wherein the bag is designed to be reusable or recyclable, contributing to a reduction in paper waste.

5. The eco-friendly bag of claim 1, wherein the bag creates a new segment within the marketing ecosystem, offering an alternative marketing channel to traditional and digital marketing methods.

6. The eco-friendly bag of claim 1, wherein the unique QR code is dynamically generated for each bag to provide personalized offers to consumers.

7. The eco-friendly bag of claim 1, wherein the marketing content includes augmented reality features that can be interacted with via the mobile application.

8. The eco-friendly bag of claim 1, wherein the marketing content is periodically updated to reflect current promotions and offers from participating brands.

9. The eco-friendly bag of claim 1, wherein the marketing content is customizable based on the geographic location of the distribution of the bags.

10. A method for utilizing an eco-friendly bag as a marketing platform, the method comprising:
providing a bag constructed from environmentally sustainable materials, featuring a main compartment with strong handles for secure transportation of food items;
displaying on the exterior surface of the bag marketing content including, but not limited to, brand advertisements, promotional messages, and discount coupons, wherein the coupons are delineated by perforated lines for easy removal and are accompanied by instructions for recycling;
distributing the bags to consumers through food service establishments, thereby directly exposing consumers to the marketing content;
scanning, via a mobile application, a unique QR code provided inside the bag to digitally access and redeem offers associated with the marketing content;
analyzing consumer interaction data collected through the mobile application to provide insights into the effectiveness of the marketing content and consumer preferences;
updating the marketing content on the bags periodically to reflect current promotions and offers, thereby maintaining relevance and engagement with consumers;
customizing the marketing content based on geographic location, demographic data, or consumer behavior to enhance targeted marketing efforts; and
encouraging consumers to recycle the bags by physically cutting out and redeeming the discount coupons, contributing to environmental sustainability and waste reduction.

11. The method of claim 10, wherein the marketing content promotes cross-marketing opportunities for both large-scale businesses and small-scale businesses.

12. A mobile application for redeeming coupons from an eco-friendly bag, the application comprising:
a user interface for scanning a QR code provided inside the bag;
a database for storing information associated with the scanned QR code, wherein the information includes at least one of: a discount coupon, a promotional offer, or an advertisement related to a brand;
a redemption module configured to allow a user to redeem the discount coupon or promotional offer;
an analytics module configured to collect data on user interactions with the QR code and the redeemed offers; and
a notification system configured to alert users of new offers and promotions related to the brands advertised on the bags.

13. The mobile application of claim 12, wherein the analytics module further provides insights to brands regarding customer preferences and the effectiveness of the marketing content.

14. The mobile application of claim 12, wherein the notification system is further configured to provide location-based alerts for offers and promotions when a user is in proximity to participating stores.

15. The mobile application of claim 12, further comprising a feature on the mobile application associated with the unique QR code, wherein the feature enables a user to share selected discount coupons with other individuals, such as friends or family members, through the application's interface.
